(19) United States
(12) Patent Application Publication
(10) Pub. No.: US 2025/0348545 A1
(43) Pub. Date: Nov. 13, 2025

(54) DOCUMENT SEARCH DEVICE, DOCUMENT SEARCH METHOD, AND RECORDING MEDIUM

(71) Applicant: NEC Corporation, Tokyo (JP)

(72) Inventors: Takuma SATO, Tokyo (JP); Yoshiyuki Etou, Tokyo (JP); Fumihiro Taniguchi, Tokyo (JP)

(73) Assignee: NEC Corporation, Tokyo (JP)

(21) Appl. No.: 19/097,935

(22) Filed: Apr. 2, 2025

(30) Foreign Application Priority Data
May 10, 2024 (JP) 2024-077275

(51) Int. Cl. G06F 16/93; G06F 16/31; G06F 16/334; G06F 16/338

(52) U.S. Cl. CPC G06F 16/93; G06F 16/325; G06F 16/334; G06F 16/338

(57) ABSTRACT

A document search device includes a memory storing instructions; and one or more processors configured to execute the instructions to: receive a prompt from a user to generate a similar text similar to a search text for document search, generate, based on the prompt, the similar text using a language model by machine learning, generate a search hash tag for the document search based on the search text and the similar text, search for a document based on the search hash tag, and output the searched document.

This application is based upon and claims the benefit of priority from Japanese Patent Application No. 2024-77275, filed on May 10, 2024, the disclosure of which is incorporated herein in its entirety by reference.

### TECHNICAL FIELD

The present invention relates to a document search device, a document search method, and a program.

### BACKGROUND ART

In JP 7416508 B1, the embodiment receives first information about a matter that the user desires to search for input by the user, and acquires a plurality of keywords evoking from the matter through a large language model using a predetermined prompt including the first information. Based on a plurality of keywords and a database storing information of a plurality of documents, displaying second information in which matters are organized for each theme of the plurality of documents is disclosed.

### SUMMARY

An object of the present disclosure is to provide a document search device and the like capable of easily finding a document to be searched for while reducing labor at the time of document search.

A document search device according to an aspect of the present disclosure includes a reception means for receiving a prompt from a user to generate a similar text similar to a search text for document search, a first generation means for generating, based on the prompt, the similar text using a language model, a second generation means for generating a search hash tag for the document search based on the search text and the similar text, a search means for searching for a document based on the search hash tag, and an output means for outputting the searched document.

A document search method executed by a computer according to an aspect of the present disclosure includes receiving a prompt from a user to generate a similar text similar to a search text for document search, generating, based on the prompt, the similar text using a language model, generating a search hash tag for the document search based on the search text and the similar text, searching for a document based on the search hash tag, and outputting the searched document.

A non-transitory recording medium in an aspect of the present disclosure stores a program for causing a computer to execute the steps of receiving a prompt from a user to generate a similar text similar to a search text for document search, generating, based on the prompt, the similar text using a language model, generating a search hash tag for the document search based on the search text and the similar text, searching for a document based on the search hash tag, and outputting the searched document.

### BRIEF DESCRIPTION OF THE DRAWINGS

Exemplary features and advantages of the present invention will become apparent from the following detailed description when taken with the accompanying drawings in which:

FIG. 1 is a block diagram illustrating a configuration of a document search device according to the present disclosure;

FIG. 2 is an example of a document and a hash tag thereof in the present disclosure;

FIG. 3 is a diagram illustrating a hardware configuration in which the document search device in the present disclosure is implemented by a computer device and its peripheral device;

FIG. 4 is a diagram for describing an example of generating a similar text in the present disclosure;

FIG. 5 is a diagram for describing generation of a search hash tag in the present disclosure;

FIG. 6 is a diagram for describing an output of a search result in the present disclosure;

FIG. 7 is a flowchart illustrating an outline of an operation of the document search device in the present disclosure;

FIG. 8 is a block diagram illustrating a configuration of a document search device according to the present disclosure;

FIG. 9 is a diagram for describing personality setting in the present disclosure;

FIG. 10 is a diagram for describing personality setting in the present disclosure;

FIG. 11 is a diagram for describing an example of generating a similar text in the present disclosure; and

FIG. 12 is a flowchart illustrating an outline of an operation of the document search device in the present disclosure.

### EXAMPLE EMBODIMENT

Hereinafter, example embodiments of a document search device, a document search method, a program, and a non-transitory recording medium recording the program according to the present disclosure will be described in detail with reference to the drawings. The present example embodiment does not limit the disclosed technology.

### First Example Embodiment

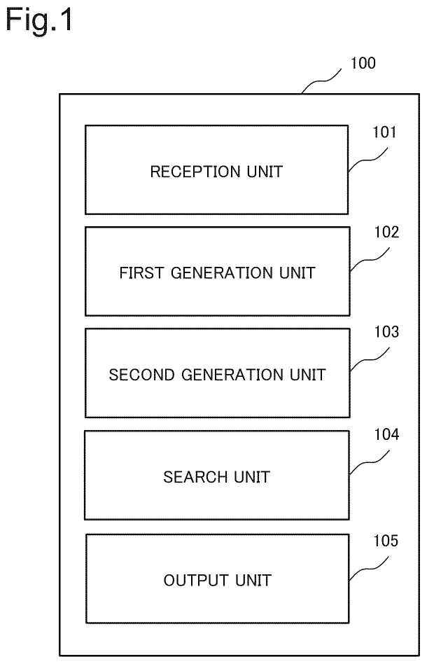

FIG. 1 is a block diagram illustrating a configuration of a document search device 100 according to the present disclosure. As illustrated in FIG. 1, the document search device 100 includes a reception unit 101, a first generation unit 102, a second generation unit 103, a search unit 104, and an output unit 105. The document search device 100 of the present disclosure is, for example, a device for a user such as an employee of a company to search for a document configured in a natural language accumulated in the company.

Examples of the document to be searched for include an internal document transmitted to the inside of the company, a message by e-mail or chat, word-of-mouth information about a product, and the like. In the present disclosure, an internal document will be described as a search target, but the document to be searched for is not limited thereto. In the present disclosure, it is assumed that a hash tag (hereinafter, referred to as a “document hash tag”) is assigned to each of the documents to be searched for.

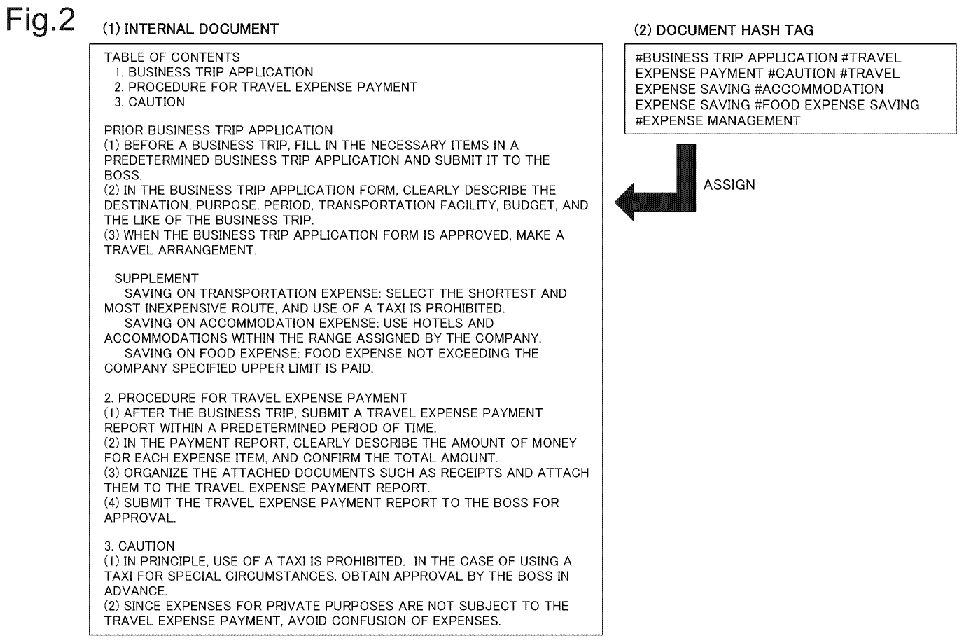

FIG. 2 is an example of a document and its hash tag in the present disclosure. As illustrated in FIG. 2, (2) a document hash tag is assigned to (1) an internal document. The number of assigned hash tags may be singular or plural.

In a case where a plurality of document hash tags is assigned to the document to be searched for, a weight indicating the content of the document may be set to each of the document hash tags based on an appearance rate in the entire document to be searched for. In a document hash tag having a low appearance rate, the rate at which the document hash tag is assigned to other internal documents is low, and it is considered to be more related to the content of the document. This weight is set with a higher numerical value as the appearance rate is lower. For example, in the example of FIG. 2, a document hash tag “#business trip application, #travel expense payment, #caution, #travel expense saving, #accommodation expense saving, #food expense saving, #expense management” is assigned, and, for example, it is assumed that the appearance rates are “#business trip application (appearance rate 50%), #travel expense payment (appearance rate 20%), #caution (appearance rate 80%), #travel expense saving (appearance rate 40%), #accommodation expense saving (appearance rate 30%), #food expense saving (appearance rate 30%), #expense management (appearance rate 70%)”. In this case, the weight indicating the content may be set higher as the appearance rate is lower, such as “#business trip application (weight 5), #travel expense payment (weight 8), #caution (weight 2), #travel expense saving (weight 6), #accommodation expense saving (weight 7), #food expense saving (weight 7), #expense management (weight 3)”.

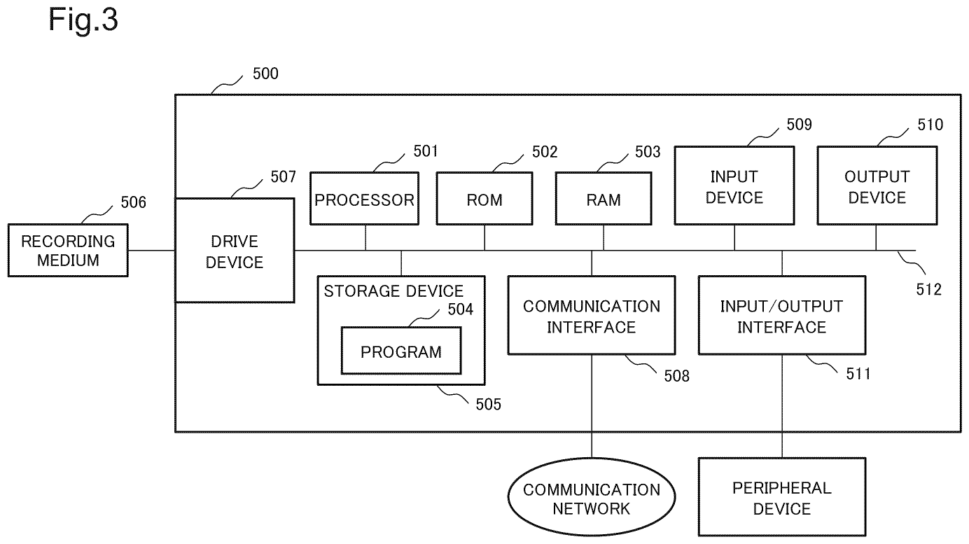

FIG. 3 is a diagram illustrating an example of a hardware configuration in which the document search device 100 in the present disclosure is achieved by a computer device 500 including a processor. As illustrated in FIG. 1, the document search device 100 includes a processor 501, a memory such as a read only memory (ROM) 502 and a random access memory (RAM) 503, a storage device 505 such as a hard disk that stores a program 504, a communication interface (I/F) 508 for network connection, and an input/output interface 511 that inputs and outputs data.

The processor 501 controls the entire computer device 500. As the processor 501, for example, a central processing unit (CPU), a digital signal processor (DSP), a graphics processing unit (GPU), a micro processing unit (MPU), a floating point number processing unit (FPU), a physics processing unit (PPU), a tensor processing unit (TPU), a quantum processor, a combination thereof, or the like can be used.

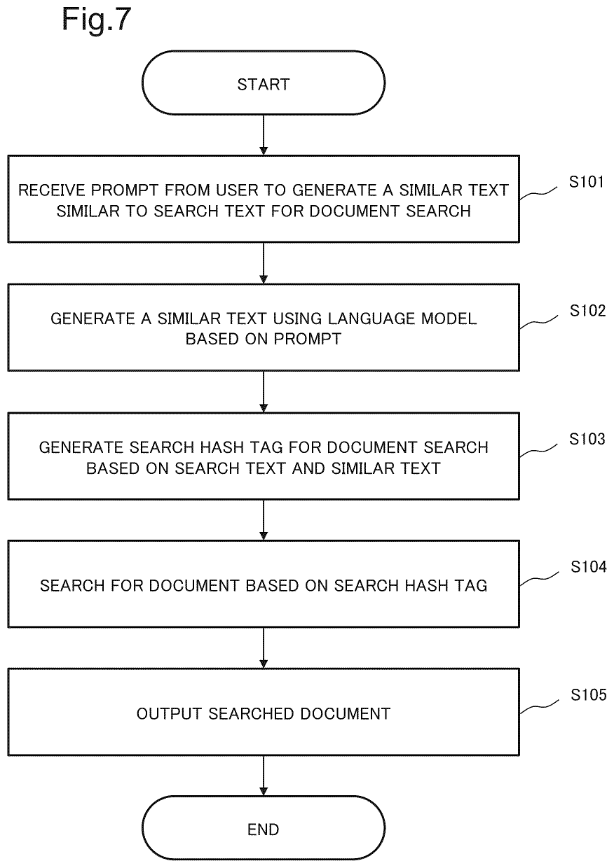

The processor 501 operates the operating system to control the entire document search device 100 according to the present disclosure. The processor 501 reads a program and data from a recording medium 506 attached to a drive device 507 or the like to a memory, for example. The processor 501 functions as the reception unit 101, the first generation unit 102, the second generation unit 103, the search unit 104, the output unit 105, and part thereof in the present disclosure, and executes processing or a command in the flowchart illustrated in FIG. 7 described later based on a program.

The recording medium 506 is, for example, an optical disk, a flexible disk, a magnetic optical disk, an external hard disk, a semiconductor memory, or the like. Part of the recording medium of the storage device is a non-volatile storage device, and records a program therein. The program may be downloaded from an external computer (not illustrated) connected to a communication network.

An input device 509 is achieved by, for example, a mouse, a keyboard, a built-in key button, and the like, and is used for an input operation. The input device 509 is not limited to a mouse, a keyboard, and a built-in key button, and may be, for example, a touch panel. An output device 510 is achieved by, for example, a display, and is used to confirm an output.

As described above, the document search device 100 illustrated in FIG. 1 is achieved by the computer hardware illustrated in FIG. 3. However, the means for achieving each unit included in the document search device 100 in FIG. 1 is not limited to the above-described configuration. In addition, the document search device 100 may be achieved by one physically coupled device, or two or more physically separated devices may be connected in a wired or wireless manner and achieved by a plurality of these devices. For example, the input device 509 and the output device 510 may be connected to the computer device 500 via a network. The document search device 100 illustrated in FIG. 1 can also be configured by cloud computing or the like.

The reception unit 101 is a means for receiving a generation prompt for generating similar text similar to the search text for document search from the user. The generation prompt is a prompt to be input into a language model to be described later. The reception unit 101 receives, for example, a generation prompt for generating a search text created by the user and a similar text similar to the search text through an application program for browsing the document to be searched for. The search text includes a search sentence or a search word indicating content desired to be searched for by the user. The generation prompt may include an instruction to generate a plurality of similar texts or an instruction to generate a similar text using a wide range of expressions. The reception unit 101 may receive a search hash tag candidate for document search from the user.

The first generation unit 102 is a means for generating the similar text using the language model based on the generation prompt. The first generation unit 102 inputs a generation prompt input from the user to the language model. As the language model, a known machine learning engine or a natural language processing algorithm can be appropriately used. As a language model, a large language model (LLM), or a transfer model obtained by transfer learning of the large language model. As the large language model, for example, generative pre-training-2 (GPT-2), GPT-3, or GPT-4 can be used. As the large language model, a text-to-text transfer transformer (T5), bidirectional encoder representations from transformers (BERT), a robustly optimized BERT approach (RoBERTa), or an efficiently learning an encoder that classifies token replacements accurately (ELECTRA) may be used. The language model may be stored in the storage device 505 or may be a model configured in an external system.

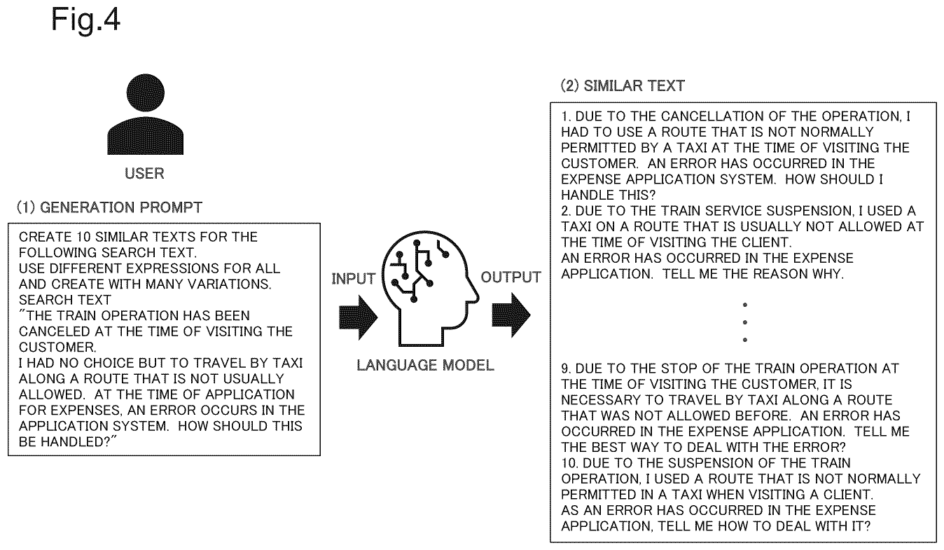

Here, an example of generating a similar text in the present disclosure will be described with reference to the drawings. FIG. 4 is a diagram for describing an example of generating similar text in the present disclosure. In the example of FIG. 4, as the (1) generation prompt, a generation prompt such as “Create 10 similar texts for the search sentence. Use all different expressions and create variations” is input to the language model in addition to the search text. The search text includes a description of the situation such that the user identifies a document to refer to.

When the first generation unit 102 inputs a generation prompt to the language model, a plurality of similar texts as illustrated in FIG. 4(2) is output. In the example of FIG. 4, since the generation prompt includes creating 10 similar texts, 10 similar texts are output.

The second generation unit 103 is a means for generating a search hash tag for document search based on the search text and the similar text. The second generation unit 103 generates search hash tags from the search text and the similar text by using various known methods. For example, the second generation unit 103 extracts a word or a phrase included in the search text and the similar text, and adds “#” to the beginning of the extracted word or phrase to create a search hash tag. The second generation unit 103 may generate the search hash tag from the search text and the similar text using a language model such as LLM. The second generation unit 103 generates search hash tags for the similar texts by the number of generated similar texts. The second generation unit 103 collects search hash tags generated for the search text and the similar text, and outputs the search hash tags to the search unit 104.

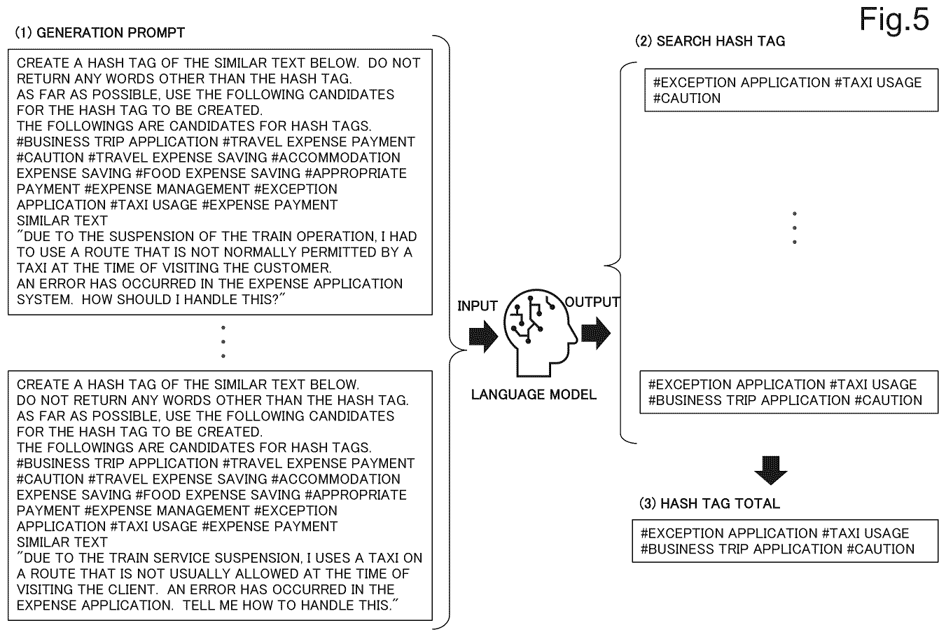

FIG. 5 is a diagram for describing generation of a search hash tag in the present disclosure. As illustrated in FIG. 5(1), the second generation unit 103 inputs a generation prompt for generating a search hash tag from the search text and the similar text to the language model. The generation prompt includes a search hash tag candidate for document search input by the user and a request to generate a hash tag. The generation prompt may include specification of an output format. When the second generation unit 103 inputs a generation prompt to the language model, the search hash tag of the search text and each similar text are output as illustrated in FIG. 5(2). As illustrated in FIG. 5(3), the second generation unit 103 collects search hash tags generated for the search text and each similar text. In the example of FIG. 5(3), all the generated search hash tags are collected by the second generation unit 103. Hereinafter, the collected search hash tag is simply referred to as a search hash tag.

The search unit 104 is a means for searching for a document based on the search hash tag. The search unit 104 searches for the document to be searched for by collating the search hash tag with the document hash tag. Specifically, the search unit 104 extracts a document candidate in which one of the search hash tags matches or is similar to one of the document hash tags. The similarity of the hash tags is appropriately determined, and for example, the similarity may be determined by matching part of both hash tags. The search method by the search unit 104 is not limited to the above-described method, and various existing methods can be used.

When there is a plurality of document candidates, the search unit 104 may calculate the similarity between the document hash tag of each of the plurality of document candidates and the search hash tag and search for the document based on the similarity. The similarity is a value that is appropriately calculated based on the number of matching or similar hash tags between the document hash tag and the search hash tag. In a case where the weight of the content is set to the document hash tag, the similarity is calculated by, for example, multiplying the weight of the content of the matching or similar hash tag. For example, the search unit 104 outputs, to the output unit 105, a document to which a document hash tag having a similarity of a predetermined value or more is assigned.

The output unit 105 is a means for causing a display device such as a display to output the searched document. The output unit 105 causes, for example, a terminal device used by the user to display information of the searched document. In the information of the searched document, the information about the search hash tag and the search hash tag matched with the document hash tag may be displayed. As a result, the validity of the search result can be indicated to the user. The search unit 104 may output the document candidates in descending order of similarity as the search result, may highlight the document candidate having the highest similarity, or may display only the document candidate having the highest similarity.

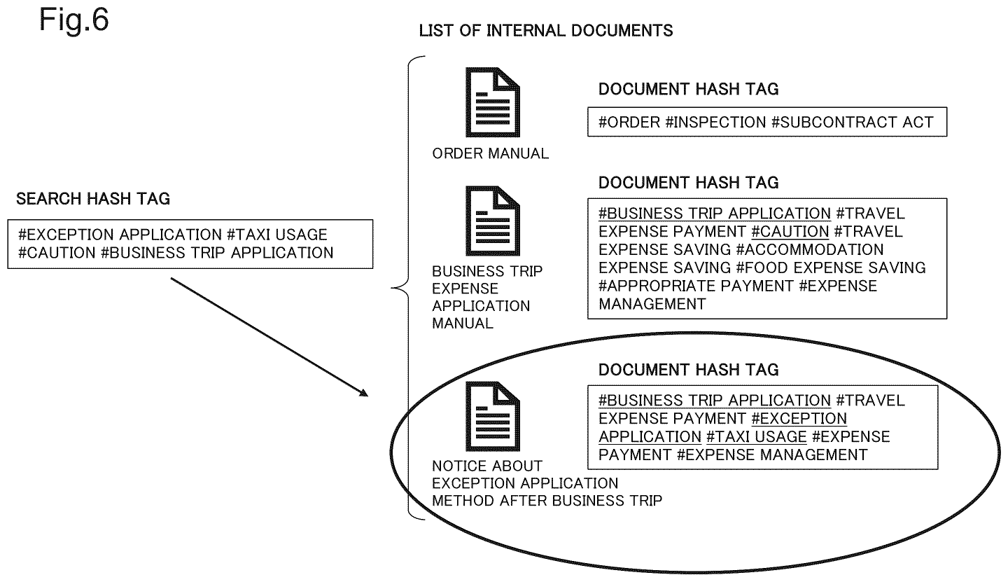

FIG. 6 is a diagram for describing an output of a search result in the present disclosure. The example of FIG. 6 is an exemplary case where the search hash tag is “#exception application, #taxi usage, #caution, #business trip application”. Among the internal documents displayed in the list of the internal documents, search hash tags matching the document hash tags of “business trip expense application manual” and “notice about exception application method after business trip” are shown. In FIG. 6, the underlined document hash tag matches the search hash tag. The output unit 105 highlights “notice about exception application method after business trip” in which the number of matching hash tags is larger.

The operation of the document search device 100 configured as described above will be described with reference to the flowchart of FIG. 7.

FIG. 7 is a flowchart illustrating an outline of an operation of the document search device 100 in the present disclosure. Note that the processing according to this flowchart may be executed based on program control by the processor described above.

As illustrated in FIG. 7, first, the reception unit 101 receives a prompt for generating a similar text similar to the search text for document search from the user (step S101). Next, the first generation unit 102 generates the similar text using the language model based on the prompt (step S102). Next, the second generation unit 103 generates a search hash tag for document search based on the search text and the similar text (step S103). Next, the search unit 104 searches for a document based on the search hash tag (step S104). Finally, the output unit 105 outputs the searched document (step S105). Thus, the document search device 100 ends the document search operation.

In the document search device 100, the first generation unit 102 generates the similar text using the language model based on a prompt for generating the similar text similar to the search text for document search received from the user. The second generation unit 103 generates a search hash tag for document search based on the search text and the similar text, and the search unit 104 searches for the document based on the search hash tag. As a result, it is possible to easily find a document to be searched for while reducing the time and effort at the time of document search in which the user inputs the search word.

### Second Example Embodiment

Next, the second example embodiment of the present disclosure will be described in detail with reference to the drawings. Hereinafter, description of contents overlapping with the above description will be omitted to the extent that the description of the present example embodiment is not unclear. As in the computer device illustrated in FIG. 3, the function of each component in each exemplary example embodiment of the present disclosure can be achieved not only by hardware but also by a computer device or software based on program control.

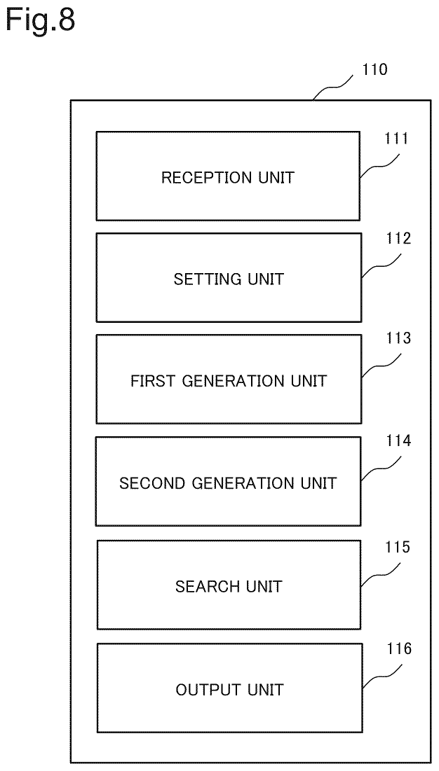

FIG. 8 is a block diagram illustrating a configuration of a document search device 110 according to the present disclosure. With reference to FIG. 8, the document search device 100 will be described focusing on a part different from the document search device 110. The document search device 110 includes a reception unit 111, a setting unit 112, a first generation unit 113, a second generation unit 114, a search unit 115, and an output unit 116. Components in the present example embodiment are the same as the related components in the first example embodiment except for the setting unit 112 and the first generation unit 113.

The setting unit 112 is a means for setting a plurality of personalities for generating similar text for the language model. The personality is an individual characteristic, for example, an occupation or a role. The role may include content to be output for the input information, desired behavior, and the like. The setting unit 112 may set, as the plurality of personalities, at least an author who generates a similar text, a reviewer who reviews the similar text, and a manager who instructs the author and the reviewer. By providing the language model with the personality of the professional profession, the possibility of enhancing the ability of each professional is increased, and a similar text suitable for document search can be generated.

The setting unit 112 may input, to the language model, a constraint condition such as a rule to be followed together with the personality. After the personality is set, the setting unit 112 may set a constraint condition for generating a similar text through an interaction between a plurality of personalities. In this case, the constraint condition is stored in, for example, the storage device 505 or the like, and is set by appropriately referring to the constraint condition during the interaction.

The setting unit 112 may further set a judge for determining validity of the generated similar text as the plurality of personalities. The validity of the similar text is, for example, whether the content deviates from the content desired to be searched for by the user. More specifically, the judge is given a role of, for example, comparing the user search word with the similar text and deleting content not included in the search text input by the user or false information. For example, the setting unit 112 may set the request the judge of for determining the validity every time the reviewer inspects the similar text.

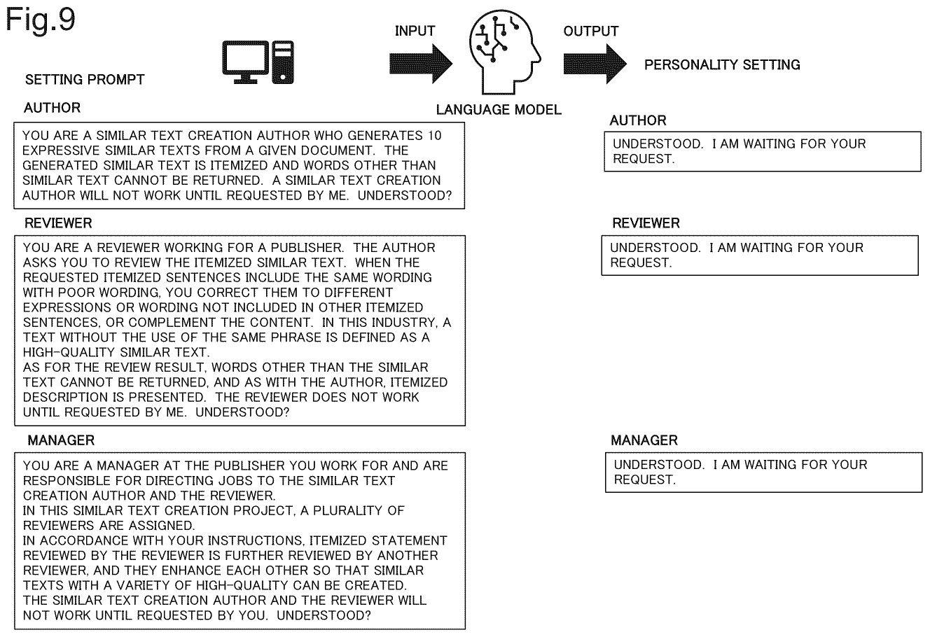

Here, a procedure for setting the personality in the language model will be described with reference to FIG. 9. FIG. 9 is a diagram for describing the setting of the personality of the language model in the present disclosure. As illustrated in FIG. 9, the setting unit 112 sets the personality by inputting a setting prompt for setting the personality to the language model. The setting prompt may include confirmation of a personality to be set, a role to be set, and statement of not to be output until there is an instruction. The role includes content to be output for the input information.

In the example of FIG. 9, the setting prompt includes the content of the role of each personality in addition to giving a plurality of personalities of the author, the reviewer, and the manager. For example, in a setting prompt of a writer, a part of “You are a similar text creation author who generates 10 expressive similar sentences from a given document. The generated similar text is itemized and cannot return words other than similar text.” corresponds to a role given to the writer.

In the setting prompt of the example of FIG. 9, a part of “The similar text creation author will not work until I make a request.”, “The reviewer does not work until I make a request.”, and “The similar text creation author and the reviewer will not work until you make a requested.” correspond to confirmation of not outputting until there is an instruction.

In the example of FIG. 9, after the personality is assigned, “Understood?” is input in order to make the language model stop the output, such as “Understood”. In a case where there is no prompt to stop the output of the language model such as “Understood”, the output of the language model cannot be controlled, and there is a possibility that information different from the content presented by the user starts to be output before the instruction to create the similar text.

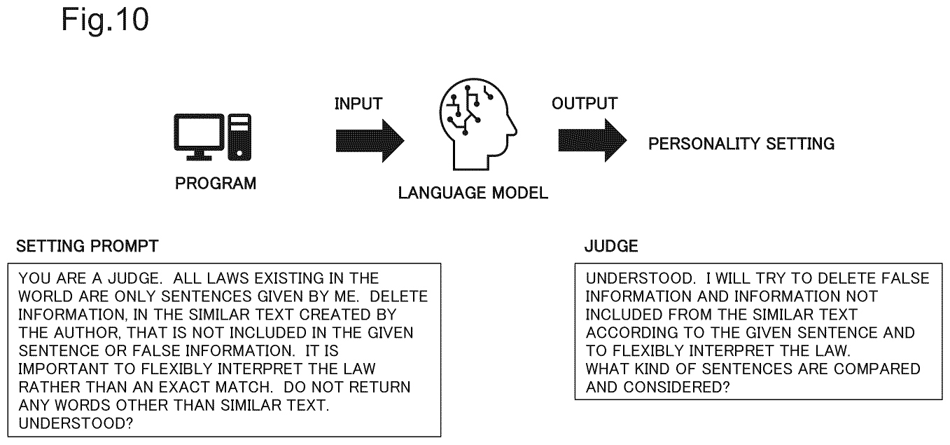

The example of FIG. 10 is an example of a setting prompt when a role of a judge is given. In the example of FIG. 10, the setting prompt of the judge includes the role of the judge in addition to giving the personality of the judge. The setting prompts in FIG. 10 include methods for the judge to determine validity, such as “All laws existing in the world are only documents given by me.” and “It is important to flexibly interpret the law rather than an exact match.”. In the example of FIG. 10, the judge asks a question to ask a condition for determining the validity of the similar text such as “What documents are compared and considered?”. In this case, the language model refers to a determination condition stored in the storage device 505 or the like, and answers the question.

The first generation unit 113 generates the similar text through an interaction using a prompt among a plurality of personalities set for the language model. The prompt includes a name of a person with a personality who requests generation of a similar text, a request for generation of the similar text, or a request for review. The prompt may include specification of an output format.

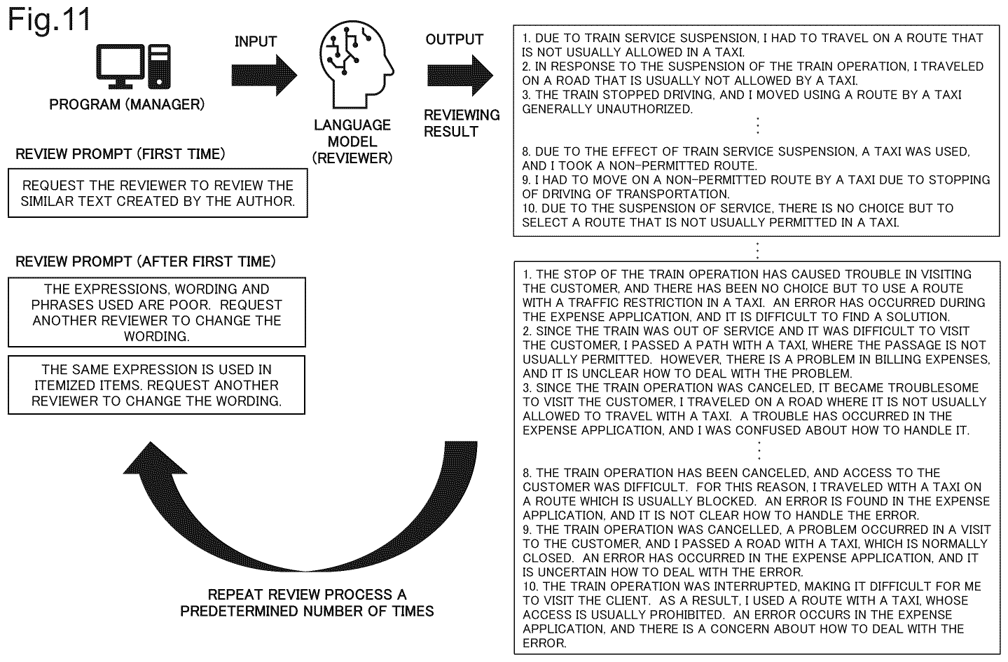

FIG. 11 is a diagram for describing an example of generating similar text in the present disclosure. Here, an example of generating a similar text through an interaction using a prompt among the author, the reviewer, and the manager will be described with reference to FIG. 11. In this case, for the similar text generated by the author, processing of an instruction for review and a review are repeatedly performed between the reviewer and the manager.

In the example of FIG. 11, a review prompt including an instruction to the reviewer by the manager to change the expression of similar text in order to generate a similar sentence with a wide variety is input to the language model. The language model at the time of performing the review process may be a language model different from the language model used for generating the similar text. The review prompt input by the manager to the reviewer may be content for repeatedly executing different reviews, or a plurality of review prompts prepared in advance may be randomly selected and input by a program. The example of FIG. 11 illustrates an example of repeatedly requesting the reviewer to perform review. More specifically, first, “Request the reviewer to review the similar text created by the author.” is input to the language model, and the reviewer outputs a review result for the similar text. Next, a review prompt “The expressions, wording and phrases used are poor. Request another reviewer to change the wording.” is input to the language model, and a review result related to the setting prompt is output. A setting prompt “The same expression is used in itemized items. Request another reviewer to change the wording.” is input to the language model, and the reviewer outputs a review result. In this way, by repeating a plurality of review processes, it is possible to generate a similar text with a wide variety. By making a request to a reviewer different from the reviewer who has been requested once, there is an increased possibility that a similar text having a different expression from the already generated similar text can be generated.

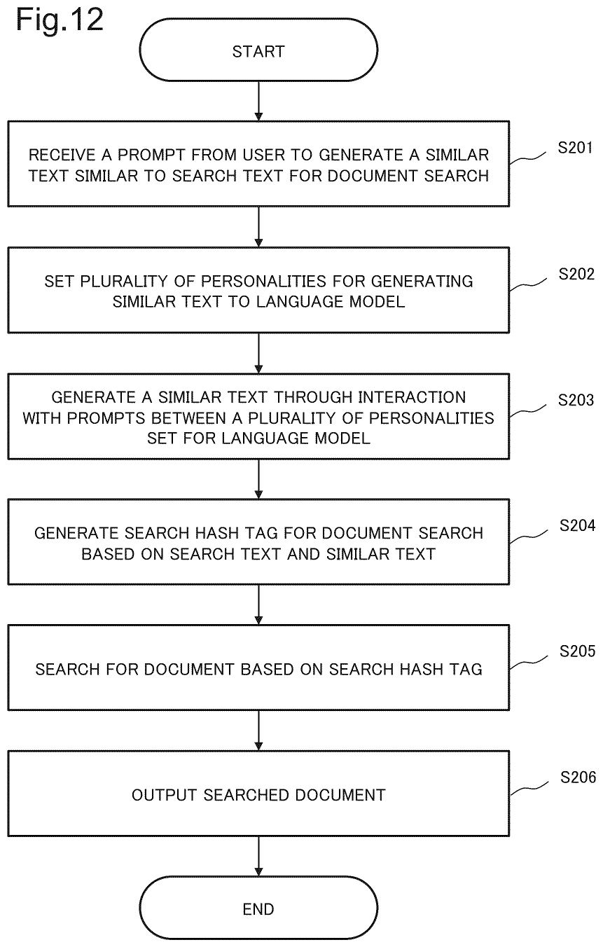

The operation of the document search device 110 configured as described above will be described with reference to the flowchart of FIG. 12.

FIG. 12 is a flowchart illustrating an outline of the operation of the document search device 110 in the present disclosure. Note that the processing according to this flowchart may be executed based on program control by the processor described above.

As illustrated in FIG. 12, first, the reception unit 111 receives a prompt for generating a similar text similar to the search text for document search from the user (step S201). Next, the setting unit 112 sets a plurality of personalities for the language model in order to generate a similar text (step S202). Next, the first generation unit 113 generates the similar text through the interaction using the prompt among the plurality of personalities set for the language model (step S203). Next, the second generation unit 114 generates a search hash tag for document search based on the search text and the similar text (step S204). Next, the search unit 115 searches for a document based on the search hash tag (step S205). Finally, the output unit 116 outputs the searched document (step S206). Thus, the document search device 110 ends the document search operation.

In the document search device 110, the setting unit 112 sets a plurality of personalities for generating similar text for the language model. The first generation unit 113 generates the similar text through an interaction using a prompt among the plurality of personalities set for the language model. As a result, for example, by giving a role of reviewing the similar text in addition to a role of generating the similar text, it is possible to perform control to increase variations of the similar text. As the variation of the similar text increases, it is possible to more easily find the document to be searched for.

The document search device 110 may further include a judge who determines validity of the generated similar text as the plurality of personalities. In this case, when the variation of the similar text is increased, the similar text deviating from the document to be searched for can be excluded.

Although the present invention is described with reference to each example embodiment, the present invention is not limited to the above example embodiments. Various modifications that can be understood by those of ordinary skill in the art can be made to the configuration and details of the present invention within the scope of the present invention.

For example, although the plurality of operations is described in order in the form of a flowchart, the order of description does not limit the order in which the plurality of operations is executed. Therefore, when each example embodiment is implemented, the order of the plurality of operations can be changed within a range that does not interfere with the content. In the second example embodiment, the setting unit 112 includes, as the plurality of personalities, an author who generates a similar text, a reviewer who reexamines the similar text, and a manager that instructs the author and the reviewer. However, the personality set by the setting unit 112 is not limited thereto as long as a role necessary for increasing variations of the similar text to be generated is given.

As the document of the present disclosure, an internal document related to a business trip application is described as an example, but the document of the present disclosure is not limited to the internal document. The document may be a document managed in an organization. The invention of the present disclosure is also applicable to electronic medical record information such as nursing records in the medical field, care records in the care field, childcare records in the childcare field, manuals of industrial machine or software, design documents, and failure information documents. The document is not limited to a document managed in the organization, and may be, for example, a document on the Web.

The nursing record is created at a nursing site in order to plan, implement, and evaluate the nursing care plan, or to make a medical worker's decision. The format of the nursing record includes a subject object assessment plan (SOAP) format, a focus charting format, and a time recording format, all of which are formats including a natural language. At the time of nursing care plan evaluation or medical litigation, nurses need to search for supporting documents from their vast nursing records. With the document search device of the present disclosure, it is possible to more easily find a document to be searched for.

For example, in general, in an organization, natural language based information such as a document, a message by e-mail or chat, and word-of-mouth information of a product is accumulated in a huge amount. A user who searches for information searches for information by inputting a search word in order to search for necessary information.

As disclosed in JP 7416508 B1, when information search is performed using a search word input by a user, a search result depends on the search word input by the user. When the necessary information cannot be obtained, the user has to repeat the search word correction and search.

An example of an effect of the present disclosure is to make it easy to find a document to be searched for while reducing time and effort at the time of document search.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Various modifications that can be understood by those of ordinary skill in the art can be made to the configuration and details of the present disclosure within the scope of the present invention.

Although the plurality of operations is described in order in the form of a flowchart, the order of description does not limit the order of executing the plurality of operations. Therefore, when each example embodiment is implemented, the order of the plurality of operations may be changed within a range that does not interfere with the content.

Further, it is noted that the inventor's intent is to retain all equivalents of the claimed invention even if the claims are amended during prosecution.

### Supplementary Note

### (Supplementary Note 1)

A document search device including
a reception means for receiving a prompt from a user to generate a similar text similar to a search text for document search,
a first generation means for generating, based on the prompt, the similar text using a language model,
a second generation means for generating a search hash tag for the document search based on the search text and the similar text,
a search means for searching for a document based on the search hash tag, and
an output means for outputting the searched document.

### (Supplementary Note 2)

The document search device according to Supplementary Note 1, wherein
the reception means further receives a search hash tag candidate for document search, and
searches for the document based on the search hash tag and the search hash tag candidate.

### (Supplementary Note 3)

The document search device according to Supplementary Note 1, wherein
a document hash tag is assigned to each of the documents to be searched for, and
the search means searches for the document by collating the search hash tag with the document hash tag.

### (Supplementary Note 4)

The document search device according to Supplementary Note 3, wherein
when the search results in a plurality of document candidates, the search means further calculate similarity between the document hash tag of each of the plurality of document candidates and the search hash tag, and
the output means output the document based on the similarity.

### (Supplementary Note 5)

The document search device according to Supplementary Note 4, wherein
a weight indicating content of each of the documents is set to each of the document hash tags based on an appearance rate in an entire document to be searched for, and
the search means calculate the similarity based on the weight.

### (Supplementary Note 6)

The document search device according to Supplementary Note 1, further including
a setting means for setting, for the language model, a plurality of personalities for generation of the similar text, wherein
a first generation means generates the similar text through an interaction using a prompt among a plurality of personalities set for the language model.

### (Supplementary Note 7)

The document search device according to Supplementary Note 6, wherein
the plurality of personalities includes at least an author who generates a similar text, a reviewer who reviews the generated similar text, and a manager who gives an instruction to the author and the reviewer.

### (Supplementary Note 8)

The document search device according to Supplementary Note 7, further including a judge who determines validity of the generated similar text as the plurality of personalities.

### (Supplementary Note 9)

A document search method executed by a computer, the method including
receiving a prompt from a user to generate a similar text similar to a search text for document search,
generating, based on the prompt, the similar text using a language model,
generating a search hash tag for the document search based on the search text and the similar text,
searching for a document based on the search hash tag, and
outputting the searched document.

### (Supplementary Note 10)

A program for causing a computer to execute the steps of
receiving a prompt from a user to generate a similar text similar to a search text for document search,
generating, based on the prompt, the similar text using a language model,
generating a search hash tag for the document search based on the search text and the similar text,
searching for a document based on the search hash tag, and
outputting the searched document.

Some or all of the configurations described in the Supplementary Notes 2 to 8 dependent on the Supplementary Note 1 described above can also be dependent on the Supplementary Notes 9 and 10 by the same dependency relationship as the Supplementary Notes 2 to 8. Not limited to the Supplementary Notes 1, 9, and 10, part or all of the configurations described as the Supplementary Notes can be similarly dependent on various recording devices or systems for recording various hardware, software, and software without departing from the above-described embodiments.

1. A document search device comprising:
a memory storing instructions; and
one or more processors configured to execute the instructions to:
receive a prompt from a user to generate a similar text similar to a search text for document search;
generate, based on the prompt, the similar text using a language model;
generate a search hash tag for the document search based on the search text and the similar text;
search for a document based on the search hash tag; and
output the searched document.

2. The document search device according to claim 1, wherein
the one or more processors are further configured to execute the instructions to:
further receive a search hash tag candidate for document search; and
search for the document based on the search hash tag and the search hash tag candidate.

3. The document search device according to claim 1, wherein
a document hash tag is assigned to each of the documents to be searched for, and
the one or more processors are further configured to execute the instructions to
search for the document by collating the search hash tag with the document hash tag.

4. The document search device according to claim 3, wherein
the one or more processors are further configured to execute the instructions to:
when the search results in a plurality of document candidates, further calculate similarity between the document hash tag of each of the plurality of document candidates and the search hash tag; and
output the document based on the similarity.

5. The document search device according to claim 4, wherein
a weight indicating content of each of the documents is set to each of the document hash tags based on an appearance rate in an entire document to be searched for, and
the one or more processors are further configured to execute the instructions to
calculate the similarity based on the weight.

6. The document search device according to claim 3, wherein
the one or more processors are further configured to execute the instructions to
set, for the language model, a plurality of personalities for generation of the similar text, and
generate the similar text through an interaction using a prompt among a plurality of personalities set for the language model.

7. The document search device according to claim 6, wherein
the plurality of personalities includes at least an author who generates a similar text, a reviewer who reviews the generated similar text, and a manager who gives an instruction to the author and the reviewer.

8. The document search device according to claim 7, wherein
the plurality of personalities further includes a judge who determines validity of the generated similar text.

9. A document search method by a computer, the information processing method comprising:
receiving a prompt from a user to generate a similar text similar to a search text for document search;
generating, based on the prompt, the similar text using a language model;
generating a search hash tag for the document search based on the search text and the similar text;
searching for a document based on the search hash tag; and
outputting the searched document.

10. A non-transitory computer-readable recording medium that records a program for causing a computer to execute:
receiving a prompt from a user to generate a similar text similar to a search text for document search;
generating, based on the prompt, the similar text using a language model;
generating a search hash tag for the document search based on the search text and the similar text;
searching for a document based on the search hash tag; and
outputting the searched document.
